(19) United States
(12) Patent Application Publication
(10) Pub. No.: US 2026/0013469 A1
(43) Pub. Date: Jan. 15, 2026

(54) Pet Finder/Locater, Rescue Tracker and Danger Detection Device

(71) Applicant: Suzanne Williams, Ft. Lauderdale, FL (US)

(72) Inventor: Suzanne Williams, Ft. Lauderdale, FL (US)

(21) Appl. No.: 19/334,497

(22) Filed: Sep. 19, 2025

Related U.S. Application Data
(63) Continuation-in-part of application No. 18/446,912, filed on Aug. 9, 2023, now abandoned.
(60) Provisional application No. 63/398,696, filed on Aug. 17, 2022.

(51) Int. Cl. A01K 11/00; A01K 29/00; A61J 7/00; G06F 3/01; G06F 3/16; G06F 21/32; G06V 40/10; G06V 40/20

(52) U.S. Cl. CPC A01K 11/008; A01K 29/007; A61J 7/0084; G06F 3/017; G06F 3/167; G06F 21/32; G06V 40/10; G06V 40/28

(57) ABSTRACT

A novel pet finder and rescue tracker device is disclosed. The device is a microchip that can be fastened to a collar by way of a tag or pendant, incorporated into the pet's collar itself, implanted under the animal's skin like a standard microchip, or secured to a smart watch if used with a person. The pet finder and rescue tracker device comprises a body component comprising a battery, a microchip, a location tracking component, an audible component, at least one light, and a transmitter/transceiver. Typically, when the microchip/body component senses danger, it will light up and start flashing and making noise to aid those in search of the animal. The schematic on the app will also light up in the location of where the animal is, in order to aid in its rescue.

### CROSS-REFERENCE TO RELATED APPLICATION

The present application is a continuation-in-part patent application of, and claims priority to and the benefit of, U.S. patent application Ser. No. 18/446,912, which was filed on Aug. 9, 2023, and which claims priority to, and the benefit of, U.S. Provisional Application No. 63/398,696, which was filed on Aug. 17, 2022, both of which are incorporated herein by reference in their entirety.

### FIELD OF THE INVENTION

The present invention relates generally to the field of pet finder/rescue tracker/danger detections devices. More specifically, the present invention relates to a trackable microchip/danger detection device for pets designed to locate cats, dogs, and other animals during emergencies, pet theft, or if the pet is otherwise missing. This device will also be an app that owner can remotely turn on the strobe to flash and/or sound so when people see the pet they know it is lost and will be able to return it. This will make it known to everyone in contact or that sees it that this pet is lost or in danger. Pets with regular microchips quite often don't get taken to get scanned or the chip gets missed and owners and pets are never reunited or during emergencies, they are not found. Wearing this device so it is seen, or if implanted, wearing even just the devices emblem in the form of a pendant or tags, will let everyone know the pet is owned and needs help, thereby saving lives of lost pets all over the world. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in pet finder/rescue tracker devices. Generally, locating a pet during an emergency like house fires, severe weather crises, and other similar situations can be dangerous, difficult, and time consuming. Pets are understandably scared and may try to hide despite the imminent danger. Accordingly, owners may end up seriously injured and/or killed trying to look for their pets during these types of emergencies. Thus, pets may not be found in time and end up seriously injured or dead, because they are not found in time.

Furthermore, it has been estimated that one out of every three pets will get lost in their lifetime and unfortunately, without proper identification, 90% of those pets will never return home. A microchip substantially increases the chances that a lost pet will be returned to its owner. However, microchips are generally passive devices and cannot be used to “track” a lost pet.

Accordingly, a need remains for a pet finder and rescue tracker device that is a trackable microchip device for pets. Further, a pet finder and rescue tracker device is necessary to send audible alerts and visual alerts to those physically searching for the animal and for those who come in contact with the animal when lost.

Therefore, there exists a long felt need in the art for a pet finder/rescue tracker device that provides users with a trackable microchip for pets designed to locate cats, dogs, and other animals during emergencies, pet theft, or if the pet is otherwise missing. There is also a long felt need in the art for a pet finder and rescue tracker device that enables pet owners to pair the chip wirelessly with their cell phone and/or home security system and with the fire department and/or police through the same or a separate application. Further, there is a long felt need in the art for a pet finder and rescue tracker device that automatically senses danger like excessive heat and smoke, activating and sending a signal to a smartphone, alarm company, and/or other emergency personnel through an app and displays its location on a digital map. Moreover, there is a long felt need in the art for a device that sounds an audible alert during activation to aid those physically searching for the animal. Further, there is a long felt need in the art for a pet finder and rescue tracker device that lights up and flashes so that you can see the animal in the dark or in smoky areas. Further, there is a long felt need in the art for a pet finder and rescue tracker device that an owner can remotely turn on the strobe to flash and/or sound so when people see the pet they know it is lost and will be able to return it. Further, there is a long felt need in the art of a pet finder and rescue tracker device that once the emblem or tag/pendant is seen even if the microchip is not scanned it will let everyone know the pet is owned and needs help, thereby saving lives of lost pets all over the world. Accordingly, the present disclosure makes specific reference thereto. Nonetheless, it is to be appreciated that aspects of the present invention are also equally applicable to other like applications, devices, and methods of manufacture. Finally, there is a long felt need in the art for a pet finder and rescue tracker device that saves extensive time when looking for a pet during emergencies to prevent serious injury and even death to both the pet and pet owner and rescue workers.

The subject matter disclosed and claimed herein, in one embodiment thereof, comprises a pet finder and rescue tracker. The device is a microchip that can be fastened to a collar by way of a tag or pendant, incorporated into the pet's collar itself, or implanted under the animal's skin like a standard microchip with a visible tag or pendant. The pet finder and rescue tracker device comprises a body component comprising a battery, a microchip, a location tracking component, an audible component, at least one light, and a transceiver. Typically, when the microchip senses danger, such as heat, smoke, etc., it will light up, start flashing, and making noise to aid those in search of the animal. The schematic on the app will also light up in the location of where the animal is in order to aid in its rescue, ensuring the pet owner or emergency rescue services can quickly identify the pet's location and thereby aid in preventing unnecessary injury or death to the pet, paramedic, rescue workers, or owner. Further, the device can manage more than one animal, as each animal would be identified with a different symbol representing each respective location. The device can also be used to locate a person, with the microchip being secured in a user's watch, bracelet or pendant, or other smart watch device.

In this manner, the pet finder and rescue tracker device of the present invention accomplishes all of the foregoing objectives and provides users with a device with a trackable microchip for pets and people. The device is a microchip like device with a body component that is placed inside a watch, a collar, or implanted under an animal's skin. The device senses danger, such as heat, smoke, etc., and alerts a user and will also alert the public if the pet is lost.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pet finder and rescue tracker. The device is a pet finder/locater/rescue tracker/danger detector. The device is a microchip that can be fastened to a collar by way of a tag or pendant, incorporated into the pet's collar itself, or implanted under the animal's skin like a standard microchip. The pet finder and rescue tracker device comprises a body component comprising a battery, a microchip, a location tracking component, an audible component, at least one light, and a transceiver. Typically, when the microchip senses danger, such as heat, smoke, etc., it will light up, start flashing, and making noise, as well as send alerts to a paired smart device to aid those in search of the animal.

In one embodiment, the pet finder and rescue tracker device comprises a body component comprising a battery, a microchip, a location tracking component, an audible component, at least one light, a thermal sensor, and a transceiver. The device can also include logic circuitry, including a microprocessor and other suitable components. Furthermore, the pet finder and rescue tracker device can include other components and circuitry as is necessary in utilizing the device.

In one embodiment, the body component comprises a microchip. The microchip is an identifying integrated circuit placed under the skin of a dog, cat, horse, human, or other animal, or embedded within an object, such as a pet collar, a pendant, a smart watch, etc. Microchips are typically about the size of a grain of rice and are typically based on Radio Frequency Identification (RFID) technology. Generally, a handheld RFID scanner (or “interrogator”) may be used to read an identifier code stored on the microchip using radio waves.

In one embodiment, the body component comprises a location tracking component. The location tracking component is a tracking component that is used to determine the location of the device. The location tracking component can be a GPS-based device that determines the location of the device using the Global Positioning System.

In one embodiment, the body component comprises a thermal sensor that is used to monitor the temperature of the pet or human and the temperature within proximity of the pet or human. The thermal sensor can be a thermistor or a resistance temperature detector, or any other suitable device for measuring temperature as is known in the art. Further, the thermal sensor can be a thermocouple that is configured to measure the differential temperature between the pet side of the collar and ambient temperature. The thermal sensor can be used to sense and send an alert to a user or emergency services of excessive heat and smoke near the pet.

In one embodiment, the body component comprises logic circuitry to communicate with the device components to: 1) monitor the location of the device; 2) monitor the temperature of the pet or human; 3) generate and transmit alerts regarding the location and well-being of the pet or human; 4) generate audible sounds; 5) flash the lights; and 6) remotely activate the device. Optionally, the logic circuitry can also be programmed to monitor the battery and to transmit a signal when the battery needs replacing. In one embodiment, the logic circuitry also comprises a microcontroller. The microcontroller is a small computer, often on a single integrated circuit, containing a processor core, memory, and programmable input/output peripherals.

In one embodiment, the body component comprises a transceiver, which is a communication device that transmits outbound alerts and receives inbound messages, as needed. The transceiver can be a Bluetooth or 802.11 based component or can be a cellular device that transmits messages via text messaging (SMS) services (i.e., SMS chip). Further, in one embodiment, the transceiver is a device that is used to transmit and receive radio signals.

In one embodiment, the body component comprises a battery. The purpose of the battery is to provide electrical power for use by the device. The battery can be a rechargeable battery or any other suitable battery as is known in the art. In another embodiment, the battery is configured with a USB micro port to allow for programming of the device and charging the battery.

In one embodiment, the body component comprises an audible component. The audible component can comprise at least one speaker for emitting an audible sound, alarm, noise, etc. The speaker can be any suitable speaker as is known in the art.

In one embodiment, the body component comprises at least one light. In another embodiment, there are a plurality of lights. The lights can flash, blink, and/or strobe depending on the alert being sent.

In one embodiment, the microchip part of the device is not implanted but is mounted on an animal's collar. In this embodiment, the body component is mounted directly on the collar or embedded within the collar. In another embodiment, the body component is secured within a pendant or tag then secured to the collar. In yet another embodiment, the body component is secured within a smart watch or other smart device.

In one embodiment, in operation, the body component, specifically, the logic circuitry and the transceiver, are associated with a user's smart phone or other smart device that is designated to receive messages from the device. Specifically, the smart device utilizes an application that communicates with the device to control the functions of the device. The app allows a user to visualize the pet's (or person's) location, wherein the schematic on the app will light up in the location where the animal or human is in order to aid in its rescue. Thus, the pet or person's location is displayed on a digital map. Further, additional alerts can be sent to and displayed on the smart device, such that a user is alerted if the pet or person is involved in an emergency (i.e., a fire, flood, earthquake, tornado, etc.). The alerts would be sent to a user (of a paired smart device), as well as to emergency services, an alarm company, etc.

In another embodiment, the smart device app can be utilized with more than one animal, as each animal would be identified with a different symbol representing each respective location. Generally, each animal would comprise a different microchip to identify each animal being tracked and monitored.

In one embodiment, the pet finder and rescue tracker device can be utilized to locate and monitor people, as well as animals. In this embodiment, the body component can be secured within a smart watch or other smart device as is known in the art. The device would alert another user (of a paired smart device), emergency services, an alarm company, etc., of an emergency and where a user/pet is located.

In yet another embodiment, the pet finder and rescue tracker device comprises a plurality of indicia.

In yet another embodiment, a method of tracking a pet or person to locate them during an emergency, a pet theft, or if missing is disclosed. The method includes the steps of providing a pet finder and rescue tracker device comprising a body component with a microchip, a location tracking component, an audible component, and at least one light. The method also comprises securing the body component on a pet's collar or a user's smart watch. Further, the method comprises activating the pet finder and rescue tracker device. The method also comprises pairing the pet finder and rescue tracker device with an app on a user's smart phone. Finally, the method comprises utilizing the pet finder and rescue tracker device to track and locate a pet or person, as needed.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the pet finder and rescue tracker device of the present invention showing the device with the microchip in accordance with the disclosed architecture;

FIGS. 2A-2B illustrate a front perspective view of one embodiment of the pet finder and rescue tracker device of the present invention showing the device secured within a pet collar and secured to a pet collar by way of a pendant in accordance with the disclosed architecture;

FIG. 3 illustrates a block diagram of the wireless communication module in communication with a smart device and the pet finder and rescue tracker device of the present invention in accordance with the disclosed architecture;

FIG. 4 illustrates a front perspective view of one embodiment of the pet finder and rescue tracker device of the present invention showing the device secured within a smart watch in accordance with the disclosed architecture;

FIG. 5 illustrates a flowchart showing the method of tracking a pet or person to locate them during an emergency, a pet theft, or if missing in accordance with the disclosed architecture; and

FIG. 6 illustrates a graphical view of additional features of one embodiment of the pet finder and rescue tracker device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a pet finder and rescue tracker device that provides users with a trackable microchip device/component for pets designed to locate cats, dogs, and other animals during emergencies, pet theft, or if the pet is otherwise missing. There is also a long felt need in the art for a pet finder and rescue tracker device that enables pet owners to pair the chip wirelessly with their cell phone and/or home security system and with the fire department and/or police through the same, or a separate, application. Further, there is a long felt need in the art for a pet finder and rescue tracker device that automatically senses danger, like excessive heat and smoke, activating and sending a signal to a smartphone, alarm company, and/or other emergency personnel through an app and displays its location on a digital map. Moreover, there is a long felt need in the art for a device that sounds an audible alert during activation to aid those physically searching for the animal. Further, there is a long felt need in the art for a pet finder and rescue tracker device that lights up and flashes so that you can see the animal in the dark or in smoky areas. Finally, there is a long felt need in the art for a pet finder and rescue tracker device that saves extensive time when looking for a pet during emergencies to prevent serious injury and even death to both the pet and pet owner.

The present invention, in one exemplary embodiment, is a novel pet finder and rescue tracker device. The device is a microchip that can be fastened to a collar by way of a tag or pendant, incorporated into the pet's collar itself, implanted under the animal's skin like a standard microchip, or secured within a smart watch if used to locate a person. The pet finder and rescue tracker device comprises a body component comprising a battery, a microchip, a location tracking component, an audible component, at least one light, and a transceiver. Typically, when the microchip senses danger, it will light up and start flashing and making noise to aid those in search of the animal. The schematic on the app will also light up in the location of where the animal is in order to aid in its rescue, ensuring the pet owner or emergency rescue services can quickly identify the pet's location. The present invention also includes a novel method of tracking a pet or person to locate them during an emergency, a pet theft, or if missing. The method includes the steps of providing a pet finder and rescue tracker device comprising a body component with a microchip, a location tracking component, an audible component and at least one light. The method also comprises securing the body component on a pet's collar or a user's smart watch. Further, the method comprises activating the pet finder and rescue tracker device. The method also comprises pairing the pet finder and rescue tracker device with an app on a user's smart phone. Finally, the method comprises utilizing the pet finder and rescue tracker device to track and locate a pet or person, as needed.

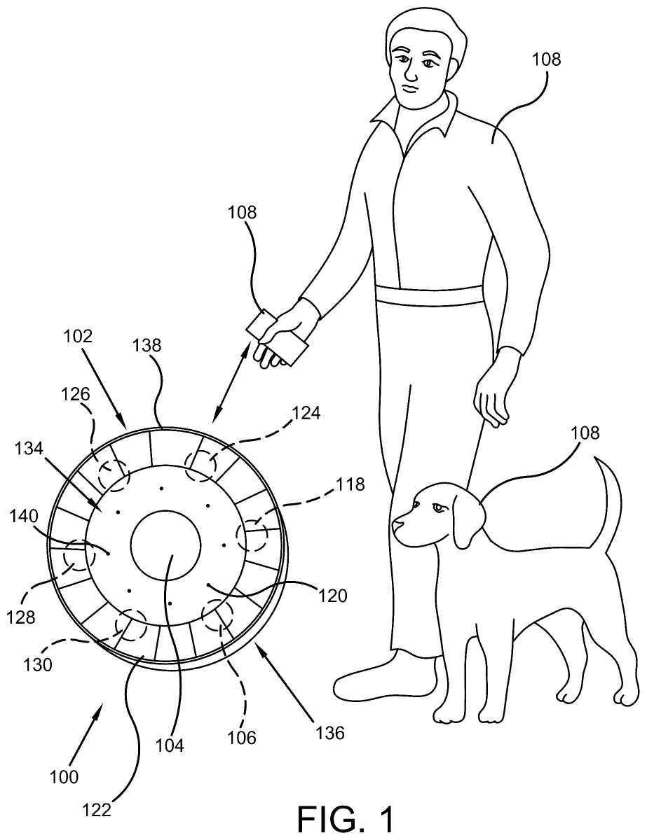

Referring initially to the drawings, FIG. 1 illustrates a perspective view of one embodiment of the pet finder and rescue tracker device 100 of the present invention. The device 100 is a pet finder/locater/rescue tracker/danger detector. In the present embodiment, the pet finder and rescue tracker device 100 is an improved pet finder and rescue tracker device 100 that tracks and locates an animal 110 or person 112. The device 100 is a microchip 104 that can be fastened to a collar 114, a smart device 116, or implanted under the animal's skin like a standard microchip. Further, the device 100 comprises a body component 102 with a battery 106, a microchip 104, and other suitable components. Typically, when the microchip 104 senses danger, such as heat, smoke, fire, etc., it will light up, start flashing, and making noise, as well as sending alerts to a paired smart device 108 to aid those in search of the animal 110 or person 112.

Generally, the pet finder and rescue tracker device 100 comprises a body component 102 comprising a battery 106, a microchip 104, a location tracking component 118, an audible component 120, at least one light 122, a thermal sensor 124, and a transceiver 126. The device 100 can also include logic circuitry 128, including a microcontroller 130 and other suitable components and circuitry that allow the components of the device 100 to communicate with each other, as well as send alerts, flash lights, and/or emit audible alarms, as needed. Furthermore, the pet finder and rescue tracker device 100 can include other components and circuitry as is necessary in utilizing the device 100, and/or different embodiments of the device 100. The body component 102 can be any suitable size and shape as is known in the art. Generally, the body component 102 is circular in shape, but can be any suitable shape as is known in the art, such as rectangular, square, oval, etc. The body component 102 also comprises a top surface 134, a rear surface 136, and side walls 138.

Further, the body component 102 comprises a microchip 104. The microchip 104 is an identifying integrated circuit placed under the skin of a dog, cat, horse, human 112, or other animal 110, or embedded within an object, such as a pet collar 114, a pendant 132, a smart watch 116, etc. Microchips 104 are typically about the size of a grain of rice and are typically based on Radio Frequency Identification (RFID) technology. Generally, a handheld RFID scanner (or “interrogator”) may be used to read an identifier code stored on the microchip 104 using radio waves. Further, the microchip 104 would be secured within the body component 102 via any suitable securing means as is known in the art, such as adhesives, etc. Once secured to the body component 102, the body component 102 and the microchip 104 are secured within a collar 114 or smart device 116 via any suitable securing means as is known in the art. Additionally, the body component 102 and microchip 104 can be secured within or on a pendant 132 or tag that is then affixed to the collar 114 via any suitable securing means as is known in the art. The pendant 132 or tag can be any suitable shape and size as is known in the art, depending on the needs and/or wants of a user, and/or the size of the animal wearing the collar 114.

Additionally, the body component 102 comprises a location tracking component 118. The location tracking component 118 is a tracking component that is used to determine the location of the device 100. The location tracking component 118 can be a GPS based device that determines the location of the device 100 using the Global Positioning System.

Furthermore, the body component 102 comprises a thermal sensor 124 that is used to monitor the temperature of the pet 110 and the temperature within the proximity of the pet 110. The thermal sensor 124 can be a thermistor or a resistance temperature detector, or any other suitable device for measuring temperature as is known in the art. Further, the thermal sensor 124 can be a thermocouple that is configured to measure the differential temperature between the pet side of the collar 114 and ambient temperature. The thermal sensor 124 can be used to sense and send an alert to a user and/or emergency services of excessive heat, fire, and smoke near the pet 110.

Additionally, the body component 102 comprises logic circuitry 128 to communicate with the device 100 components to: 1) monitor the location of the device 100; 2) monitor the temperature of the pet 110; 3) generate and transmit alerts regarding the location and well-being of the pet 110; 4) generate audible sounds; and 5) flash the lights. Optionally, the logic circuitry 128 can also be programmed to monitor the battery 106 and to transmit a signal when the battery 106 needs replacing. In one embodiment, the logic circuitry 128 also comprises a microcontroller 130. The microcontroller 130 is a small computer, often on a single integrated circuit, containing a processor core, memory, and programmable input/output peripherals, and any other suitable components necessary for operation.

Furthermore, the body component 102 comprises a transceiver 126, which is a communication device that transmits outbound alerts and receives inbound messages, as needed. The transceiver 126 can be a Bluetooth or 802.11 based component or can be a cellular device that transmits messages via text messaging (SMS) services (i.e., SMS chip). Further, in one embodiment, the transceiver 126 is a device that is used to transmit and receive radio signals.

Generally, the body component 102 also comprises a battery 106. The purpose of the battery 106 is to provide electrical power for use by the device 100. The battery 106 can be a rechargeable battery or any other suitable battery as is known in the art. In another embodiment, the battery 106 is configured with a USB micro port (not shown) to allow for programming of the device 100 and charging the battery 106.

Typically, the battery 106 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the pet finder and rescue tracker device 100. Throughout this specification, the term “battery” may be used interchangeably to refer to one or more wet or dry cells or batteries of cells in which chemical energy is converted into electricity and used as a source of DC power. References to recharging or replacing the battery 106 may refer to recharging or replacing individual cells, individual batteries of cells, or a package of multiple battery cells as is appropriate for any given battery technology that may be used. In addition, a rechargeable embodiment of the battery 106 may be recharged using a USB port (not shown), wherein the USB port is a USB-A, USB-B, Micro-B, Micro-USB, Mini-USB, or USB-C port, etc.

Furthermore, the body component 102 comprises an audible component 120. The audible component 120 can comprise at least one speaker 140 for emitting an audible sound, alarm, noise, etc. The speaker 140 can be any suitable speaker 140 as is known in the art. The speaker 140 can be waterproof or encased in a waterproof housing to protect it from the elements and/or emergency situations. Typically, there are a plurality of speakers 140 positioned around the microchip 104, such that when the audible alarm is sounded, a user can easily hear and detect the location of the pet 110. Further, when the thermal sensor 124 senses danger, such as heat, smoke, fire, etc., the audible component 120 will sound an audible alarm via the plurality of speakers 140 to help those in search of the animal 110.

Additionally, the body component 102 comprises at least one light 122. In another embodiment, there are a plurality of lights 122. The lights 122 can flash, blink, and/or strobe depending on the alert being sent. Any suitable light 122 can be utilized with the device 100, such as an LED, etc. The lights 122 can be waterproof or encased in a waterproof housing to protect them from the elements and/or emergency situations. Typically, there are a plurality of lights 122 positioned around the microchip 104, such that when the lights are lit up, flashed, strobed, etc., a user can easily see the lights and detect the location of the pet 110. Further, when the thermal sensor 124 senses danger, such as heat, smoke, fire, etc., the lights 122 will flash, blink, and/or strobe to help those in search of the animal 110.

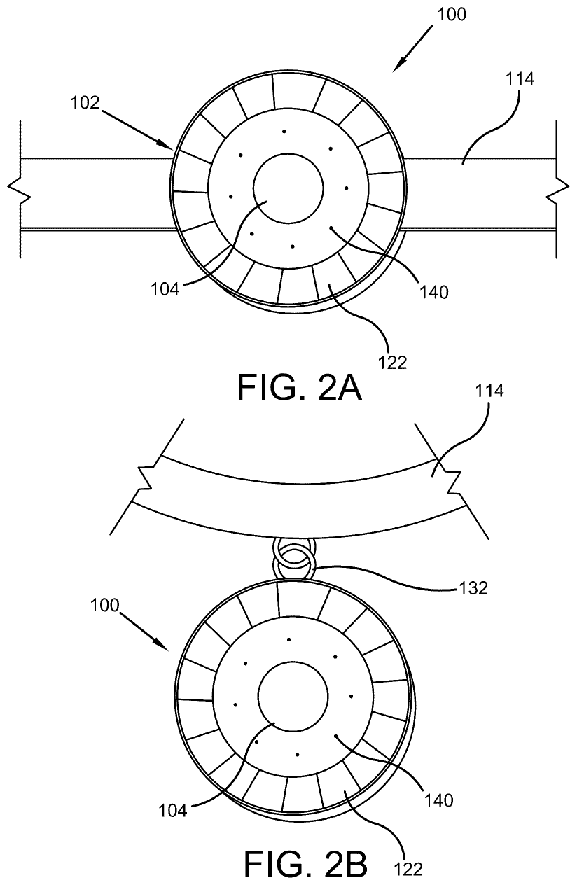

As shown in FIGS. 2A-B, the body component 102 is not implanted but is mounted on an animal's collar 114. In this embodiment, the body component 102 is mounted directly on the collar 114 or embedded within the collar 114. In another embodiment, the body component 102 is secured within a pendant 132 or tag then secured to the collar 114. In yet another embodiment, the body component 102 is secured within a smart watch or other smart device 116. Specifically, the body component 102 and the microchip 104 are secured within a collar 114 or smart device 116 via any suitable securing means as is known in the art. Additionally, the body component 102 and microchip 104 can be secured within or on a pendant 132 or tag, that is then affixed to the collar 114 via any suitable securing means as is known in the art. The pendant 132 or tag can be any suitable shape and size as is known in the art, depending on the needs and/or wants of a user, and/or the size of the animal wearing the collar 114. Furthermore, the microchip 104 of the device 100 will comprise tracking numbers 115 so the owner can be located and called and device pendants 132, collars 114, etc., and microchips 104 will be scannable.

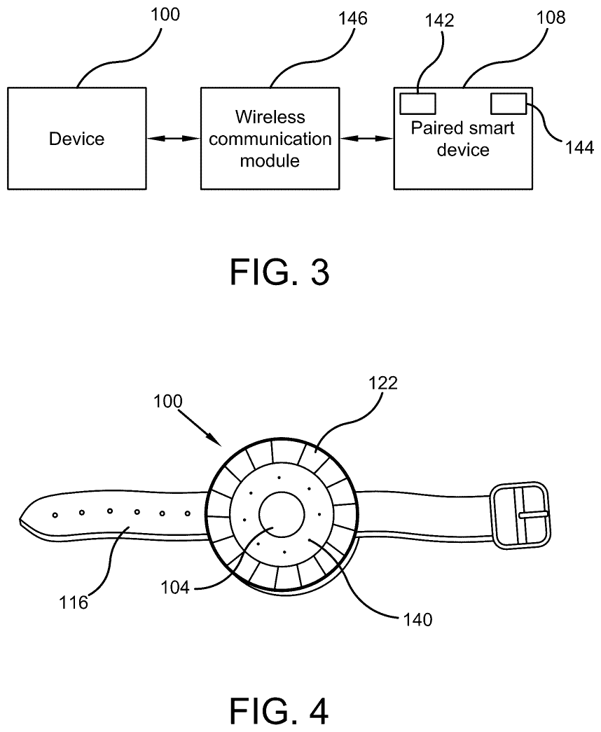

As shown in FIG. 3, in operation, the body component 102, specifically, the logic circuitry 128 and the transceiver 126 are associated with a user's smart phone or other smart device 108 that is designated to receive messages from the device 100. Specifically, the smart device 108 utilizes an application 142 that communicates with the device 100 to control the functions of the device 100. The app 142 allows a user to visualize the pet's (or person's) location, wherein the schematic on the app 142 will light up in the location where the animal 110 is in order to aid in its rescue. Thus, the pet's location is displayed on a digital map 144. Further, additional alerts can be sent to, and displayed on, the smart device 108, such that a user is alerted if the pet 110 or person 112 is involved in an emergency (i.e., fire, flood, earthquake, tornado, etc.). The alerts would be sent to a user (of a paired smart device 108), as well as to emergency services, an alarm company, etc.

Furthermore, in the application 142, the owner can remotely turn on an audible indicator 120 or a visual indicator (i.e., lights 122 that flash, blink or strobe), and/or speakers 140 that emit sound, so when people see the pet 110 they know it is lost and are able to return it. Thus, this will make it known to everyone in contact with the pet 110 or that sees the pet 110, that this pet 110 is lost or in danger. Pets 110 with regular microchips quite often don't get taken to get scanned or the microchip gets missed and owners and pets are never reunited or get euthanized at high kill shelters or get left outside to perish because no one can take them in off the street. Accordingly, wearing this device 100 so it is seen, even just the emblem, logo and/or design, will let everyone know the pet 110 is owned thereby saving lives of lost pets 110.

Further, FIG. 3 illustrates a block diagram of the wireless communication module 146 in communication with a smart device 108 and the pet finder and rescue tracker device 100 of the present invention. The pet finder and rescue tracker device 100 includes a wireless communications module 146 and additional sensors which would allow the device 100 to pair with a mobile application 142 on a smart device 108. Once paired, a user could control the pet finder and rescue tracker device 100 via the mobile application 142.

Specifically, the mobile device or smart device 108 may be a cellular telephone, a remote control, or any other device that may have wireless communication capabilities and may be connected to the internet. The mobile or smart device 108 may perform any type of wireless communication, including, but not limited to, WIFI, BLUETOOTH, RFID, NFC, etc. The device 100 further includes a wireless communication module 146 and additional sensors which would allow the device 100 to pair with a mobile application 142 on a mobile or smart device 108. Once paired, a user could control the pet finder and rescue tracker device 100 via the mobile application 142.

As shown in FIG. 4, the smart device app 142 can be utilized with more than one animal 110, as each animal 110 would be identified with a different symbol representing each respective location. Generally, each animal 110 would comprise a different microchip 104 to identify each animal 110 being tracked and monitored.

Further, the pet finder and rescue tracker device 100 can be utilized to locate and monitor people 112, as well as animals 110. In this embodiment, the body component 102 can be secured within a smart watch or other smart device 116 as is known in the art. The device 100 would alert another user (of a paired smart device 108), emergency services, alarm company, etc., of the emergency and where a user/pet is located. The body component 102 is secured within the smart device 116 via any suitable securing means as is known in the art, such as adhesives.

In another embodiment, the pet finder and rescue tracker device 100 comprises a plurality of indicia 148. The body component 102 of the device 100 may include advertising, trademark, other letters, designs, or characters, printed, painted, stamped, or integrated into the body component 102, or any other indicia 148 as is known in the art. Specifically, any suitable indicia 148 as is known in the art can be included, such as, but not limited to, patterns, logos, emblems, images, symbols, designs, letters, words, characters, animals, advertisements, brands, etc., that may or may not be animal, location, or brand related.

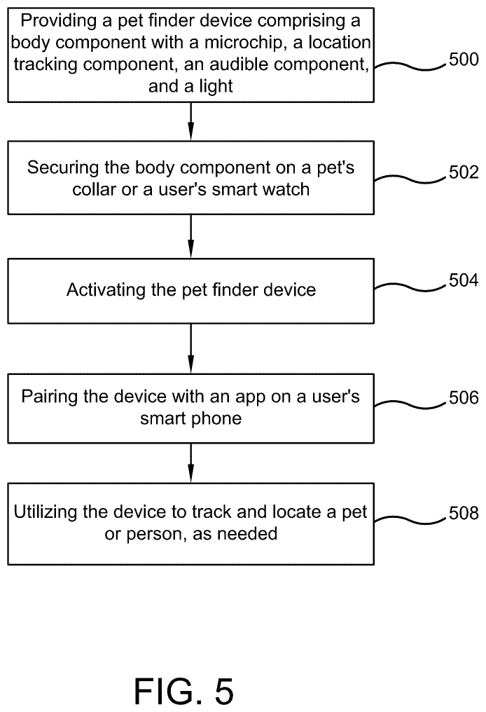

FIG. 5 illustrates a flowchart of the method of tracking a pet or person to locate them during an emergency, a pet theft, or if missing. The method includes the steps of at 500, providing a pet finder and rescue tracker device comprising a body component with a microchip, a location tracking component, an audible component, and at least one light. The method also comprises at 502, securing the body component on a pet's collar or a user's smart watch. Further, the method comprises at 504, activating the pet finder and rescue tracker device. The method also comprises at 506, pairing the pet finder and rescue tracker device with an app on a user's smart phone. Finally, the method comprises at 508, utilizing the pet finder and rescue tracker device to track and locate a pet or person, as needed.

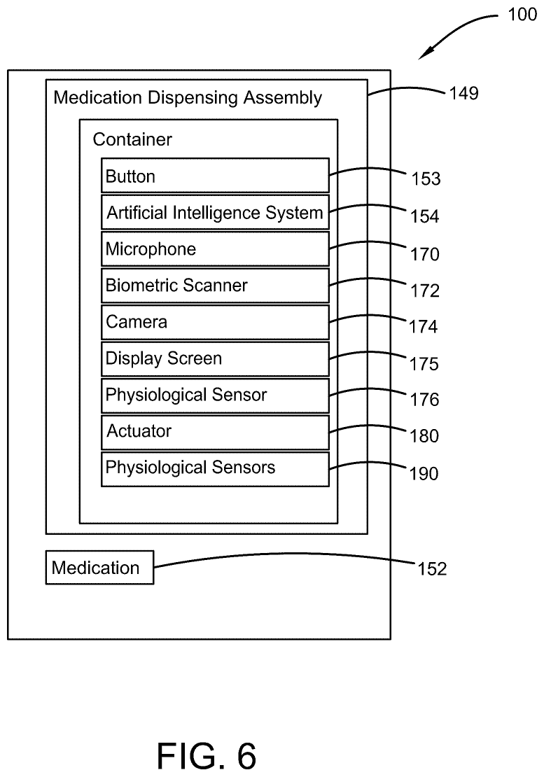

In another embodiment, the pet finder and rescue tracker device 100 is further comprised of additional features, as seen in FIG. 6. Said features may include a medication dispensing assembly 149 configured for use in emergency response scenarios involving either the pet 110 or person 112. More specifically, the medication dispensing assembly 149 may be comprised of a container 150, which is configured to hold one or more medications 152. The container 150 may be integrated into or secured to the body component 102 by any suitable means as is known in the art, such as mechanical fastening, adhesive bonding, molded integration, or magnetic attachment mechanisms. The container 150 may be configured to hold emergency medications 152 such as but not limited to naloxone (Narcan), heart medications, fentanyl reversal drugs, epinephrine, asthma inhalers, insulin, antihistamines, or other critical medications depending on the medical needs of the user or animal.

The container 150 may be activated via a plurality of methods, including but not limited to a mechanical button 153, a paired smart device 108, voice recognition via a microphone 170, biometric authentication via a scanner 172 (e.g., fingerprint or facial recognition), gesture recognition via a camera 174, inputting a passcode on a display screen 175, or automatic sensing of a predetermined event or physiological condition via at least one sensor 176. In one embodiment, upon activation an actuator 180 such as but not limited to a solenoid, servo motor, a piezoelectric element, a hinge, a spring hinge, etc. may open the container 150, permitting the controlled release of the medication 152.

In one embodiment, an artificial intelligence system 154 integrated with the logic circuitry 128 may monitor user responsiveness, physiological parameters (e.g., heart rate, respiration, temperature), geolocation, or environmental factors (e.g., presence of smoke or hazardous gases). Upon detecting a lack of user responsiveness, onset of distress indicators, or external emergency conditions, the AI system 154 may automatically initiate medication release protocols by opening the container 150 via the actuator 180.

In another embodiment, the device 100 may be worn by a service animal, wherein specific actions made by the animal may be interpreted by the logic circuitry 128 as command inputs to initiate activation of the container 150 to permit dispensing of the medication 152 to aid the animal's handler during a medical emergency. Alternatively, the medication 152 may be dispensed by manual activation, such as by pressing the button 153 located on or adjacent to the container 150.

The device 100 may be secured to a wide range of wearable items such as but not limited to a service dog vest, a human-worn vest, a collar 114, a bracelet, a necklace, a pendant 132, a waistband, or any suitable article designed to be worn on a person or animal. These configurations enable emergency medication delivery to the wearer and allow remote or autonomous activation by a designated user, sensor signal, or system. In another embodiment, the device 100 may be utilized on animals that themselves require medication. In this case, the medication dispensing assembly 149 may operate based on a schedule pre-programmed into the logic circuitry 128 or triggered by real-time detection of health-related parameters via onboard biometric or physiological sensors 190.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “pet finder and rescue tracker device”, “pet finder device”, “finder device”, and “device” are interchangeable and refer to the pet finder and rescue tracker device 100 of the present invention.

Notwithstanding the foregoing, the pet finder and rescue tracker device 100 of the present invention can be of any suitable size and configuration as is known in the art without affecting the overall concept of the invention, provided that it accomplishes the above-stated objectives. One of ordinary skill in the art will appreciate that the pet finder and rescue tracker device 100 as shown in FIGS. 1-5 are for illustrative purposes only, and that many other sizes and shapes of the pet finder and rescue tracker device 100 are well within the scope of the present disclosure. Although the dimensions of the pet finder and rescue tracker device 100 are important design parameters for user convenience, the pet finder and rescue tracker device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet finder and rescue tracker device that tracks and locates an animal, the pet finder and rescue tracker device comprising:
a body component comprised of a battery, a location tracking component, a thermal sensor, and a transceiver;
a microchip secured within the body component;
a logic circuitry disposed within the body component and configured to communicate with the microchip, the location tracking component, the thermal sensor, the transceiver, and the battery;
an audible component comprising a speaker disposed within the body component;
a light disposed within the body component;
a medication dispensing assembly comprising a container configured to hold a medication; and
wherein the thermal sensor is configured to detect heat, smoke, or fire and trigger the logic circuitry to activate the light, the audible component, and transmit an alert via the transceiver.

2. The pet finder and rescue tracker device of claim 1, wherein the medication is comprised of a naloxone, a heart medication, a fentanyl reversal drug, an epinephrine, a asthma inhaler, an insulin, or an antihistamine.

3. A pet finder and rescue tracker device that tracks and locates an animal, the pet finder and rescue tracker device comprising:
a body component comprised of a battery, a location tracking component, a thermal sensor, and a transceiver;
a microchip secured within the body component;
a logic circuitry disposed within the body component and configured to communicate with the microchip, the location tracking component, the thermal sensor, the transceiver, and the battery;
an audible component comprising a speaker disposed within the body component;
a light disposed within the body component;
a medication dispensing assembly comprising a container configured to hold a medication and an actuator; and
wherein the thermal sensor is configured to detect heat, smoke, or fire and trigger the logic circuitry to activate the light, the audible component, and transmit an alert via the transceiver.

4. The pet finder and rescue tracker device of claim 3, wherein the actuator is comprised of a solenoid, a servo motor, a piezoelectric element, a hinge, or a spring hinge.

5. The pet finder and rescue tracker device of claim 3, wherein the activation of the container releases the medication.

6. The pet finder and rescue tracker device of claim 3, wherein the container can be activated by a button.

7. The pet finder and rescue tracker device of claim 3, wherein the container can be activated by a pair smart device.

8. The pet finder and rescue tracker device of claim 3, wherein the container can be activated by a voice recognition by a microphone.

9. The pet finder and rescue tracker device of claim 3, wherein the container can be activated by a biometric authentication via a scanner.

10. The pet finder and rescue tracker device of claim 3, wherein the container can be activated by a gesture recognition via a camera.

11. The pet finder and rescue tracker device of claim 3, wherein the container can be activated by a passcode input on a display screen.

12. The pet finder and rescue tracker device of claim 3, wherein the container can be activated by an automatic sensing by a sensor.

13. The pet finder and rescue tracker device of claim 3, wherein the medication is comprised of a naloxone, a heart medication, a fentanyl reversal drug, an epinephrine, a asthma inhaler, an insulin, or an antihistamine.

14. A pet finder and rescue tracker device that tracks and locates an animal, the pet finder and rescue tracker device comprising:
a body component comprised of a battery, a location tracking component, a thermal sensor, and a transceiver;
a microchip secured within the body component;
a logic circuitry disposed within the body component and configured to communicate with the microchip, the location tracking component, the thermal sensor, the transceiver, and the battery;
an audible component comprising a speaker disposed within the body component;
a light disposed within the body component;
a medication dispensing assembly comprising a container configured to hold a medication and an actuator;
wherein the thermal sensor is configured to detect heat, smoke, or fire and trigger the logic circuitry to activate the light, the audible component, and transmit an alert via the transceiver; and
wherein the logic circuitry includes an artificial intelligence system configured to monitor a user responsiveness, a physiological parameter, a geolocation, or an environmental condition to automatically initiate release of the medication from the container upon detecting a predetermined condition.

15. The pet finder and rescue tracker device of claim 14, wherein the medication is comprised of a naloxone, a heart medication, a fentanyl reversal drug, an epinephrine, a asthma inhaler, an insulin, or an antihistamine.

16. The pet finder and rescue tracker device of claim 14, wherein the container can be activated by a voice recognition by a microphone.

17. The pet finder and rescue tracker device of claim 14, wherein the container can be activated by a biometric authentication via a scanner.

18. The pet finder and rescue tracker device of claim 14, wherein the container can be activated by a gesture recognition via a camera.

19. The pet finder and rescue tracker device of claim 14, wherein the container can be activated by a passcode input on a display screen.

20. The pet finder and rescue tracker device of claim 14, wherein the container can be activated by an automatic sensing by a sensor.
